(19) United States
(12) Patent Application Publication
(10) Pub. No.: US 2026/0235635 A1
(43) Pub. Date: Aug. 13, 2026

(54) ADD-ON MODULE ENABLING COST EFFECTIVE AND COMPACT SOLUTION FOR INSPECTING LARGE INTEGRATED CIRCUIT COMPONENT

(71) Applicant: KLA Corporation, Milpitas, CA (US)

(72) Inventors: Johan De Greeve, Heverlee (BE); Jimmy Vermeulen, Sint-Agathat-Berchem (BE); Ye Tan, Wespelaar (BE); KC Leung, Kwai Chung (HK); Shing Lui Lau, Singapore (SG); Jiun Pin Goh, Singapore (SG); Wai Yip Lau, Singapore (SG); Yuting Chai, Singapore (SG)

(21) Appl. No.: 19/180,965

(22) Filed: Apr. 16, 2025

(30) Foreign Application Priority Data
Feb. 7, 2025 (SG) 10202500348Y

(51) Int. Cl. G01N 35/00; G06T 3/4038

(52) U.S. Cl. CPC G01N 35/0099; G06T 3/4038

(57) ABSTRACT

An add-on module may enable a cost effective and compact solution for inspecting large integrated circuit components. The add-on module may be a mechatronic-indexing system. The mechatronic-indexing system may enable imaging stitching by adding a motion axis perpendicular to the main motion axes of the pick-and-place head. The mechatronic-indexing system may include a linear actuator for translation along the motion axis. The mechatronic-indexing system may also include a pick-up gear for picking and placing a sample.

### CROSS-REFERENCE TO RELATED APPLICATIONS

The present application claims the benefit under 35 U.S.C. § 119 of Singaporean (SN) Patent Application Number 10202500348Y, filed on Feb. 7, 2025, titled “Add-On Module Enabling Cost Effective and Compact Solution for Inspecting Large IC Component”, which is incorporated herein by reference in the entirety.

### TECHNICAL FIELD

The present disclosure generally relates to pick-and-place heads, and, more particularly, to drive mechanisms for the pick-and-place heads.

### BACKGROUND

In the semiconductor back-end industry, the complexity & variety of integrated circuit components are increasing rapidly. Many large single integrated circuit components (often driven by artificial intelligence application) are emerging in the market. These large integrated circuit components impose additional challenges to the back-end component inspector tools of today. The existing component inspector tools often has limited field-of-view (FOV) on its 2D/3D cameras. To inspect the larger integrated circuit components, image stitching methods are needed.

Image stitching is realized by adding extra motion capabilities either on the nozzles of a pick-and-place head, or on the vision module. That means adding extra cost (motor, driver) and weight to these hardware modules. The size of these hardware modules and the stitching motion travel range are typically constrained by the machine footprint definition. These design elements & constraints make it difficult for the stitching capability on a component inspector tool to follow the evolution of integrated circuit device sizes. Therefore, it would be advantageous to provide a device, system, and method that cures the shortcomings described above.

### SUMMARY

A mechatronic-indexing system is described, in accordance with one or more embodiments of the present disclosure. The mechatronic-indexing system may include: an indexing frame, a carriage; a shaft, wherein the shaft is affixed to the indexing frame; a linear actuator, wherein the linear actuator is coupled to the carriage, wherein the linear actuator is configured to translate the carriage relative to the indexing frame along the shaft; a pick-up gear, wherein the pick-up gear is coupled to the carriage, wherein the indexing frame is disposed between the pick-up gear and the carriage, wherein the pick-up gear includes a plurality of nozzles; and a vacuum interface, wherein the vacuum interface is coupled to one of the carriage or the pick-up gear, wherein the plurality of nozzles are configured to receive vacuum from the vacuum interface.

A pick-and-place head is described, in accordance with one or more embodiments of the present disclosure. The pick-and-place head may include: a mechatronic-indexing system including: an indexing frame, a carriage; a shaft, wherein the shaft is affixed to the indexing frame; a linear actuator, wherein the linear actuator is coupled to the carriage, wherein the linear actuator is configured to translate the carriage relative to the indexing frame along the shaft; a pick-up gear, wherein the pick-up gear is coupled to the carriage, wherein the indexing frame is disposed between the pick-up gear and the carriage, wherein the pick-up gear includes a plurality of nozzles; and a vacuum interface, wherein the vacuum interface is coupled to one of the carriage or the pick-up gear, wherein the plurality of nozzles are configured to receive vacuum from the vacuum interface; and a base, wherein the mechatronic-indexing system is configured to attach to and detach from the base.

An optical system is described, in accordance with one or more embodiments of the present disclosure. The optical system may include: a pick-and-place head including: a mechatronic-indexing system including: an indexing frame, a carriage; a shaft, wherein the shaft is affixed to the indexing frame; a linear actuator, wherein the linear actuator is coupled to the carriage, wherein the linear actuator is configured to translate the carriage relative to the indexing frame along the shaft; a pick-up gear, wherein the pick-up gear is coupled to the carriage, wherein the indexing frame is disposed between the pick-up gear and the carriage, wherein the pick-up gear includes a plurality of nozzles; and a vacuum interface, wherein the vacuum interface is coupled to one of the carriage or the pick-up gear, wherein the plurality of nozzles are configured to receive vacuum from the vacuum interface; and a base, wherein the mechatronic-indexing system is configured to attach to and detach from the base; a rail, wherein the pick-and-place head is coupled to the rail, wherein the pick-and-place head is configured to translate horizontally along the rail along a Y-axis, wherein the linear actuator is configured to cause the carriage to translate horizontally relative to the indexing frame along an X-axis; a tray, wherein the pick-up gear is configured to pick up and place a sample to and from a tray; and an imaging sub-system, wherein the pick-and-place head is configured to horizontally translate along the rail to place the sample within a field-of-view of the imaging sub-system, wherein the sample is larger than the field-of-view, wherein the imaging sub-system is configured to generate a plurality of images of the sample while the pick-and-place head translates the sample within the field-of-view in both the X-axis and the Y-axis.

A method is described, in accordance with one or more embodiments of the present disclosure. The method may include: attaching a mechatronic-indexing system to a base of a pick-and-place head, wherein the mechatronic-indexing system includes: an indexing frame, a carriage; a shaft, wherein the shaft is affixed to the indexing frame; a linear actuator, wherein the linear actuator is coupled to the carriage, wherein the linear actuator is configured to translate the carriage relative to the indexing frame along the shaft; a pick-up gear, wherein the pick-up gear is coupled to the carriage, wherein the indexing frame is disposed between the pick-up gear and the carriage, wherein the pick-up gear includes a plurality of nozzles; and a vacuum interface, wherein the vacuum interface is coupled to one of the carriage or the pick-up gear, wherein the plurality of nozzles are configured to receive vacuum from the vacuum interface; picking a sample from a tray using the pick-up gear of the mechatronic-indexing system; positioning the sample within a field-of-view of an imaging sub-system, wherein the sample is larger than the field-of-view; translating the sample within the field-of-view in both an X-axis and a Y-axis using the pick-and-place head as the imaging sub-system generates a plurality of images of the sample; stitching the plurality of images together to form a composite image of the sample; and placing the sample on the tray.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 depicts a simplified block diagram of an optical system including a pick-and-place head, in accordance with one or more embodiments of the present disclosure.

FIG. 2A depicts a perspective view of the pick-and-place head including a mechatronic-indexing system, in accordance with one or more embodiments of the present disclosure.

FIG. 2B depicts a front view of the pick-and-place head including the mechatronic-indexing system, in accordance with one or more embodiments of the present disclosure.

FIG. 2C depicts a side view of the pick-and-place head including the mechatronic-indexing system, in accordance with one or more embodiments of the present disclosure.

FIG. 2D depicts a perspective view of the pick-and-place head with the mechatronic-indexing system detached from a base, in accordance with one or more embodiments of the present disclosure.

FIG. 2E depicts a bottom perspective view of the pick-and-place head with the mechatronic-indexing system detached from the base, in accordance with one or more embodiments of the present disclosure.

FIG. 2F depicts a bottom perspective view of the pick-and-place head with the pick-up gear attached to the base, in accordance with one or more embodiments of the present disclosure.

FIG. 3A depicts a perspective view of the mechatronic-indexing system, in accordance with one or more embodiments of the present disclosure.

FIG. 3B depicts a front view of the mechatronic-indexing system, in accordance with one or more embodiments of the present disclosure.

FIG. 3C depicts a side view of the mechatronic-indexing system, in accordance with one or more embodiments of the present disclosure.

FIG. 3D depicts a bottom view of the mechatronic-indexing system, in accordance with one or more embodiments of the present disclosure.

FIG. 4A depicts a perspective view of the mechatronic-indexing system, in accordance with one or more embodiments of the present disclosure.

FIG. 4B depicts a bottom perspective view of the mechatronic-indexing system, in accordance with one or more embodiments of the present disclosure.

FIG. 4C depicts a perspective view of the mechatronic-indexing system coupled to a picker of the base, in accordance with one or more embodiments of the present disclosure.

FIG. 5 depicts a flow diagram of a method, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are directed to an add-on module enabling a cost effective and compact solution for inspecting large integrated circuit components. The add-on module may be a mechatronic-indexing system. The mechatronic-indexing system may enable imaging stitching by adding a motion axis perpendicular to the main motion axes of the pick-and-place head. The mechatronic-indexing system may include a linear actuator for translation along the motion axis. The mechatronic-indexing system may also include a pick-up gear for picking and placing a sample.

U.S. Pat. No. 8,903,541B2, titled “Method and arrangement for positioning electronic devices into compartments of an input medium and output medium”; U.S. Pat. No. 9,099,509B2, titled “Dual tray carrier unit”; U.S. Pat. No. 9,669,550B2, titled “Pick and place device with automatic pick-up-height adjustment and a method and a computer program product to automatically adjust the pick-up-height of a pick and place device”; U.S. Pat. No. 9,776,334B2, titled “Apparatus and method for automatic pitch conversion of pick and place heads, pick and place head and pick and place device”; U.S. Pat. No. 9,886,764B2, titled “Image acquisition system, image acquisition method, and inspection system”; U.S. Pat. No. 11,020,862B2, titled “Pick-and-place head and method for picking work-pieces”; U.S. Pat. No. 11,287,248B2, titled “Method and system for optical three dimensional topography measurement”; are each incorporated herein by reference in the entirety.

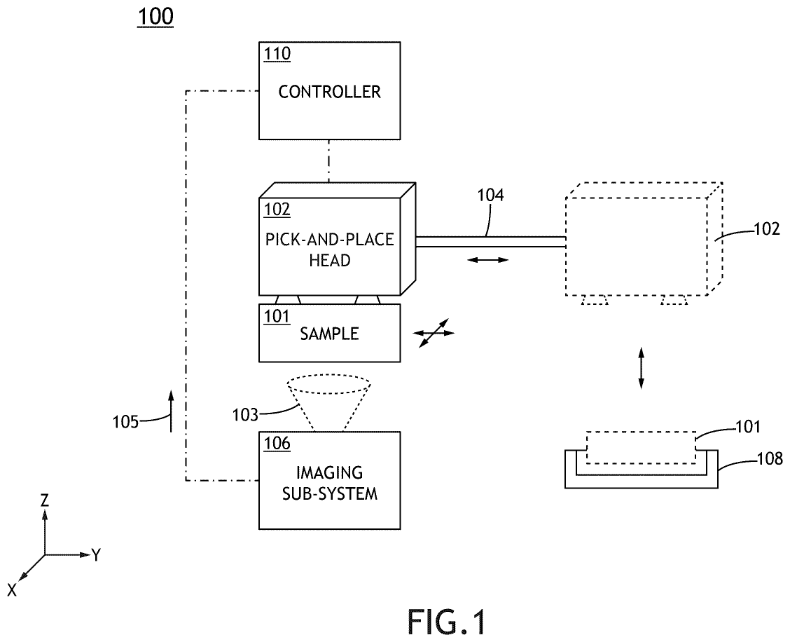

FIG. 1 depicts an optical system 100, in accordance with one or more embodiments of the present disclosure. The optical system 100 may be an optical inspection system and/or an optical metrology system. The optical system 100 may be configured to perform optically inspection and/or optical metrology on a sample 101. The optical system 100 may include one or more components, such as, but not limited to, a pick-and-place head 102, a rail 104, an imaging sub-system 106, a tray 108, and/or a controller 110.

The tray 108 may be configured to hold the sample 101. The tray 108 may be configured to translate the sample 101 via one or more conveyors (not depicted). The tray 108 may include any suitable tray, such as, but not limited to, a Joint Electron Device Engineering Council (JEDEC) tray. For example, the tray 108 may be a molded matrix carrier used during the manufacturing process of the sample 101. The sample 101 may be placed in an individual cell of the tray 108.

The rail 104 may support the pick-and-place head 102. The pick-and-place head 102 may be configured to vertically translate relative to the rail 104. For example, the pick-and-place head 102 may be configured to vertically translate relative to the rail 104 in the Z-axis. The pick-and-place head 102 may be configured to vertically translate relative to the rail 104 to pick the sample 101 from the tray 108 and to place the sample 101 on the tray 108. As used herein, the X-axis and the Y-axis are horizontal axes and the Z-axis is a vertical axis, where the X-axis, the Y-axis, and the Z-axis are each orthogonal to each other.

The pick-and-place head 102 may be configured to horizontally translate along the rail 104. For example, the pick-and-place head 102 may be configured to horizontally translate along the rail 104 in the Y-axis. The Y-axis may be the main horizontal motion axis of the pick-and-place head 102. The pick-and-place head 102 may be configured to horizontally translate along the rail 104 to place the sample 101 above the tray 108 and above the imaging sub-system 106.

The imaging sub-system 106 may include any combination of optical elements (not depicted) suitable for performing optically inspection and/or optical metrology of the sample 101. For example, the imaging sub-system 106 may include illumination sub-systems, collection sub-systems, and the like.

The imaging sub-system 106 may be configured to generate images 105 of the sample 101. The pick-and-place head 102 may be configured to support the sample 101 over the imaging sub-system 106. The imaging sub-system 106 may be configured to generate the images 105 of a backside of the sample 101 while the pick-and-place head 102 translates the sample 101 within the field-of-view 103 in both the X-axis and the Y-axis. The images 105 may be two-dimensional and/or three-dimensional images. The images 105 may be used for defect inspection and/or metrology.

The imaging sub-system 106 may generate the images 105 with a field-of-view 103. A size of the sample 101 may be larger than the field-of-view 103 such that not all of the sample 101 may be captured in one of the images 105.

The pick-and-place head 102 may be configured to translate the sample 101 relative to the imaging sub-system 106 in both the X-axis and the Y-axis. The pick-and-place head 102 may be configured to translate the sample 101 relative to the imaging sub-system 106 in the Y-axis by translating along the rail 104. The pick-and-place head 102 may be configured to translate the sample 101 relative to the imaging sub-system 106 in the X-axis using a mechatronic-indexing system 202, as will be described further herein. The translation of the sample 101 relative to the imaging sub-system 106 may allow the imaging sub-system 106 to generate multiple of the images 105 at different portions of the sample 101.

The controller 110 may be coupled to the pick-and-place head 102 and/or the imaging sub-system 106. The controller 110 may cause the pick-and-place head 102 to translate. The controller 110 may also cause the imaging sub-system 106 to generate the images 105. The controller 110 may also receive the images 105 and stitch the images 105 together to form a composite image including the entire portion of the sample 101.

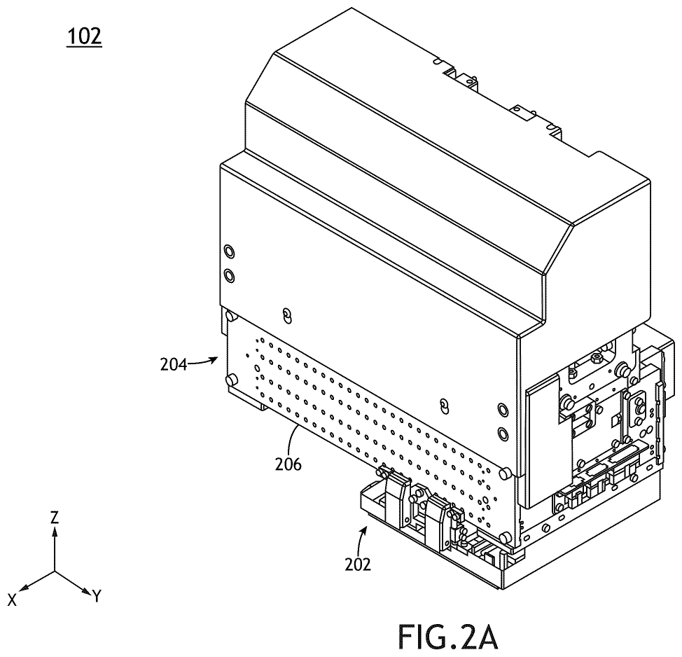

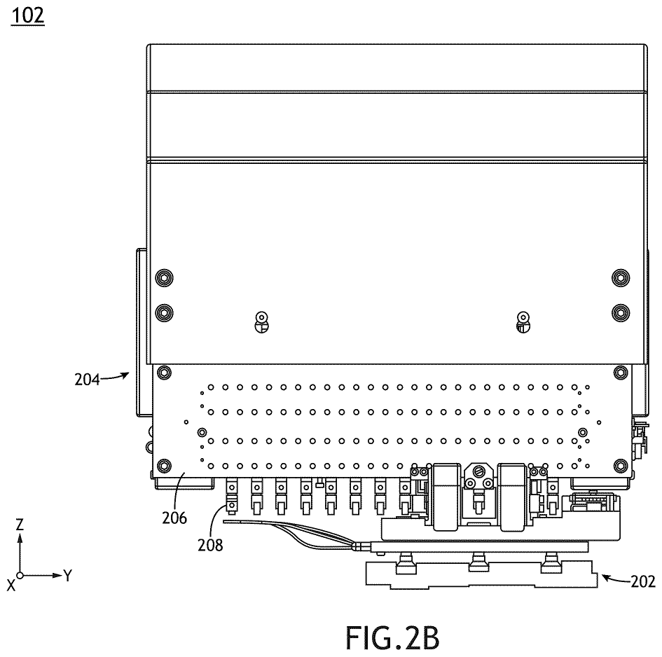

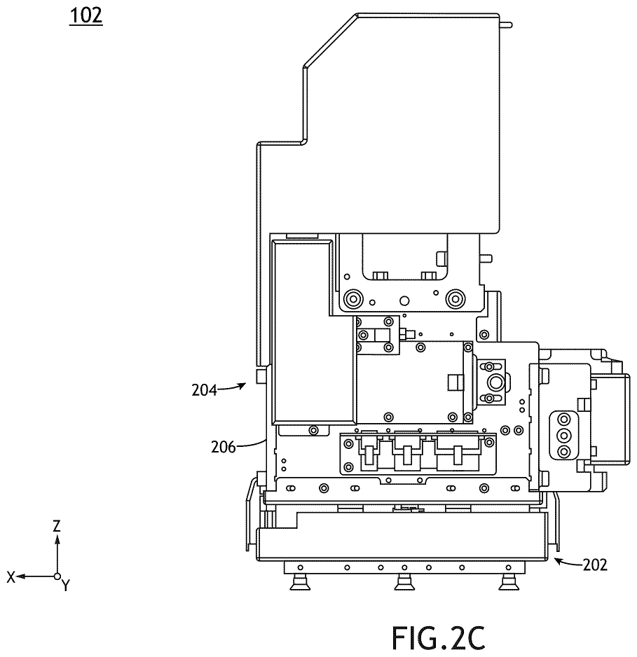

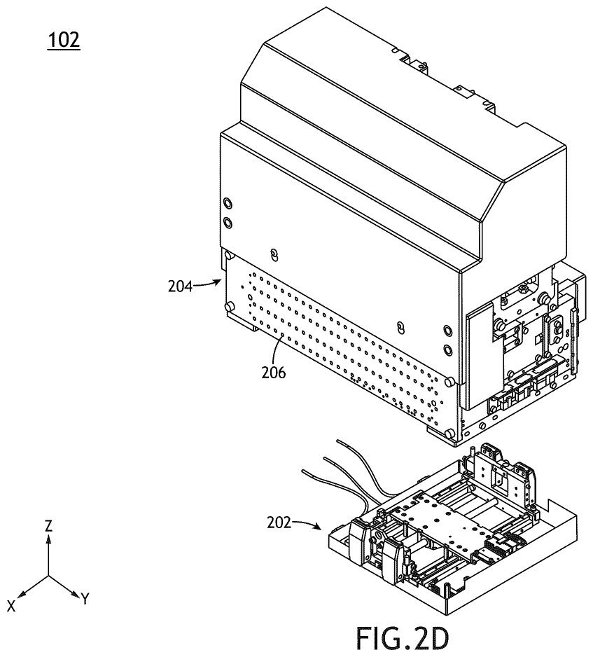

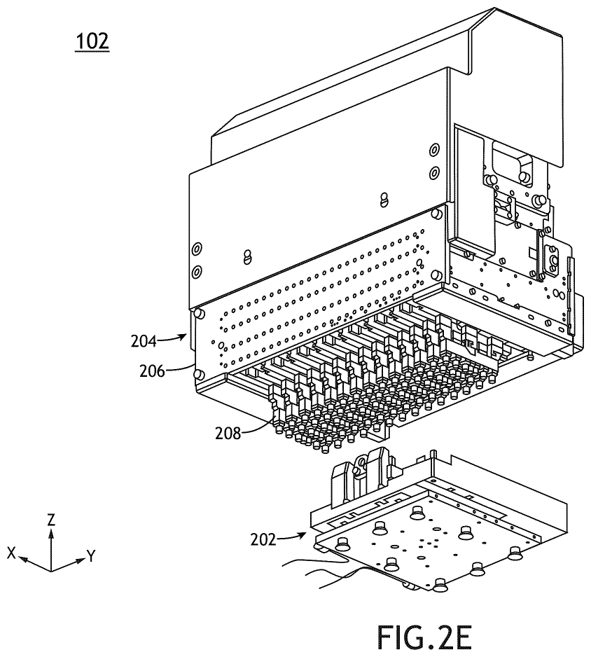

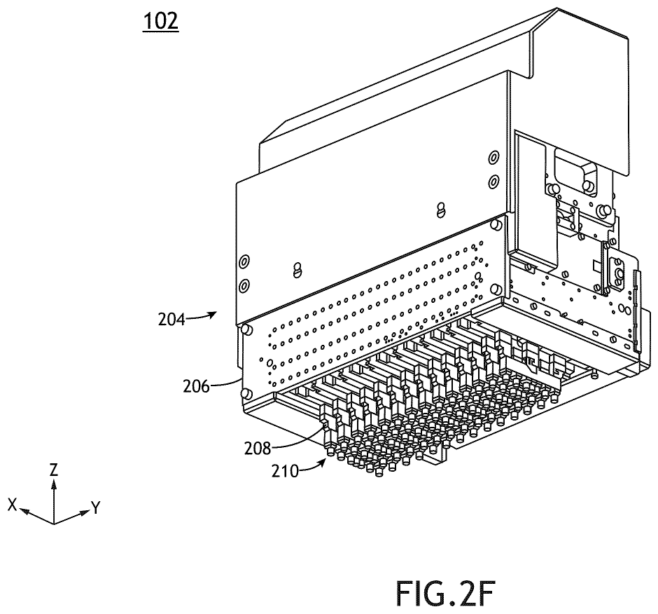

FIGS. 2A-2F depict the pick-and-place head 102, in accordance with one or more embodiments of the present disclosure. The pick-and-place head 102 may include one or more components, such as, but not limited to, a mechatronic-indexing system 202, a base 204, and/or pick-up gear 210.

The base 204 may be configured to couple to the rail 104, by which the pick-and-place head 102 is configured to horizontally translate along the Y-axis. The base 204 may include one or more components, such as, but not limited to, a base frame 206 and/or pickers 208. The base frame 206 of the base 204 may be configured to couple to the rail 104. The base frame 206 may also house the pickers 208.

The pickers 208 may also be referred to as grippers. The pickers 208 may be connected to a plurality of tubes (not depicted) which provide a vacuum supply to pick up the sample 101 from the tray 108 and/or a gas supply to place the sample 101 onto the tray 108. The vacuum supply and gas supply may include pipes, tubes, channels ultimately connected to a known source of vacuum and source of air like one or plural pumps of, where the source of vacuum is configured to remove gas and where the source of air is configured to supply air.

The pickers 208 may be arranged in N rows and M columns, where N and M are integers. The rows and columns may be aligned along the Y-axis and the X-axis, respectively. The base 204 may include any number of the pickers 208 in the rows and columns. For example, the base 204 may include the pickers 208 arranged in one row, two rows, three rows, four rows, or more. By way of another example, the base 204 may include the pickers 208 arranged in one column, six columns, fourteen columns, a number therebetween, or more. The number of N rows and the number of M columns is merely exemplary and is not intended to be limiting.

The pickers 208 may be moveably mounted to the base frame 206. The pickers 208 may be adjustable in number, pitch, and/or in pick-up height. The pitch may include an X-pitch and/or a Y-pitch. The X-pitch may refer to the distance along the X-axis between adjacent rows of the pickers 208. The Y-pitch may refer to the distance along the Y-axis between adjacent of the pickers 208. Thus, the pitch may be adjustable between adjacent rows and/or adjacent columns of the pickers 208. The pick-up height may refer to the height of the pickers 208 along the Z-axis. The pickers 208 may be adjustable in number, pitch, and/or in pick-up height for configuring the pick-and-place head 102 to pick different sizes of the samples 101 (e.g., for configuring for different sizes when the mechatronic-indexing system 202 is detached from the base 204). Picking different sizes of the samples 101 may be beneficial to cause the pick-and-place head 102 to prevent a changeover between multiple of the pick-and-place heads 102 in the optical system 100, thereby maximizing the operation time of the optical system 100.

The mechatronic-indexing system 202 may be configured to attach to and detach from the base frame 206. The mechatronic-indexing system 202 may be attached to the base 204 thereby configuring the pick-and-place head 102 to grab larger of the samples 101 for stitching together multiple of the images 105 into the composite image. The mechatronic-indexing system 202 may index the sample 101 at select positions relative to the imaging sub-system 106, thereby enabling the controller 110 to stitch together multiple of the images 105 into the composite image. Thus, the mechatronic-indexing system 202 may allow the optical system 100 to accommodate the sample 101 when the size of the sample 101 is larger than the field-of-view 103. The mechatronic-indexing system 202 may be detached from the base 204 thereby configuring the pick-and-place head 102 to grab multiples of smaller of the samples 101 without performing imaging stitching.

The mechatronic-indexing system 202 may be configured to attached to and detach from any portion of the base 204. For example, the mechatronic-indexing system 202 may be attached to and detached from the base frame 206. The mechatronic-indexing system 202 may be disposed below the base 204 when coupled to the base 204.

The pick-up gear 210 of the pick-and-place head 102 may be configured to attach to and detach from the pickers 208 when the mechatronic-indexing system 202 is detached from the base frame 206. The pick-up gear 210 may include nozzles which receive the vacuum for suctioning to multiple of the samples 101. The nozzles may receive the vacuum and/or air from one or more of the pickers 208. Multiples of the nozzles may also share the pickers 208. The nozzles of the pick-up gear 210 may be configured to match the spacing of the samples 101 in the tray 108. The pick-up gear 210 may be retooled when the configuration of the samples 101 in the tray 108 is changed. In this regard, the pick-up gear 210 may be a changeover part. The pick-up gear 210 may be configured to pick up the samples 101 which are relatively small, compared to the mechatronic-indexing system 202. For example, the pick-up gear 210 may be configured to pick up the samples 101 which are on the order of millimeters.

The mechatronic-indexing system 202 may provide several advantages for the pick-and-place head 102. For example, the mechatronic-indexing system 202 may allow the pick-and-place head 102 to pick-and-place for generating the images 105 of larger of the samples 101 by stitching without increasing the field-of-view 103 of the imaging sub-system 106 and/or without adjusting the base 204.

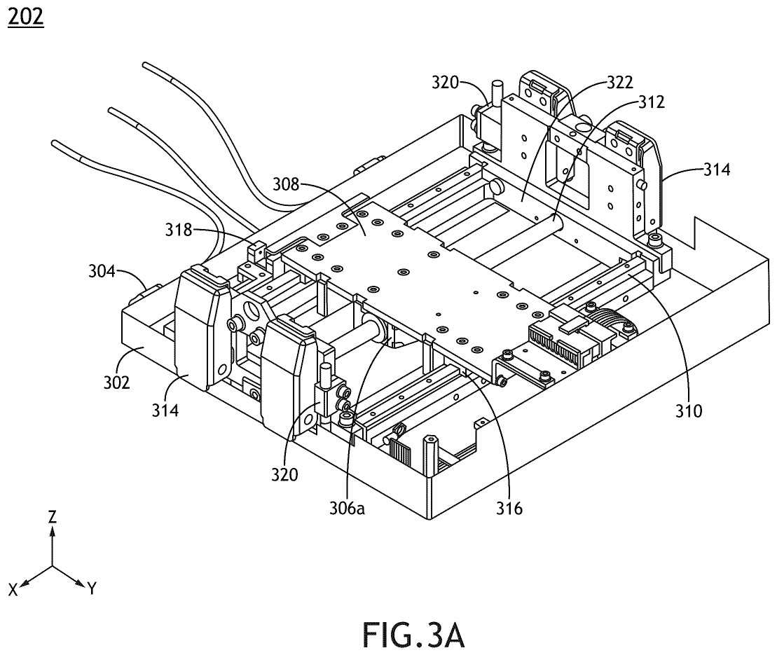

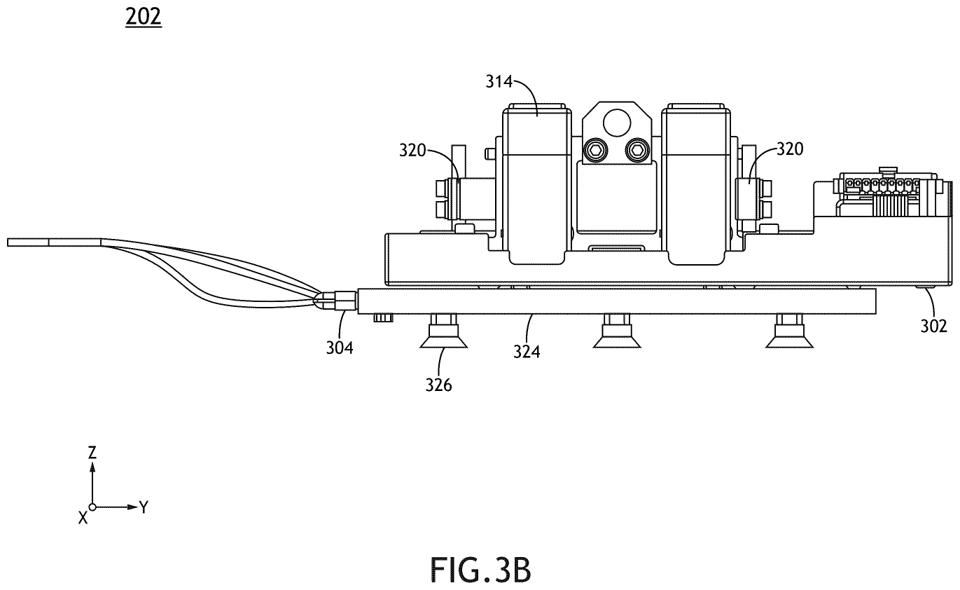

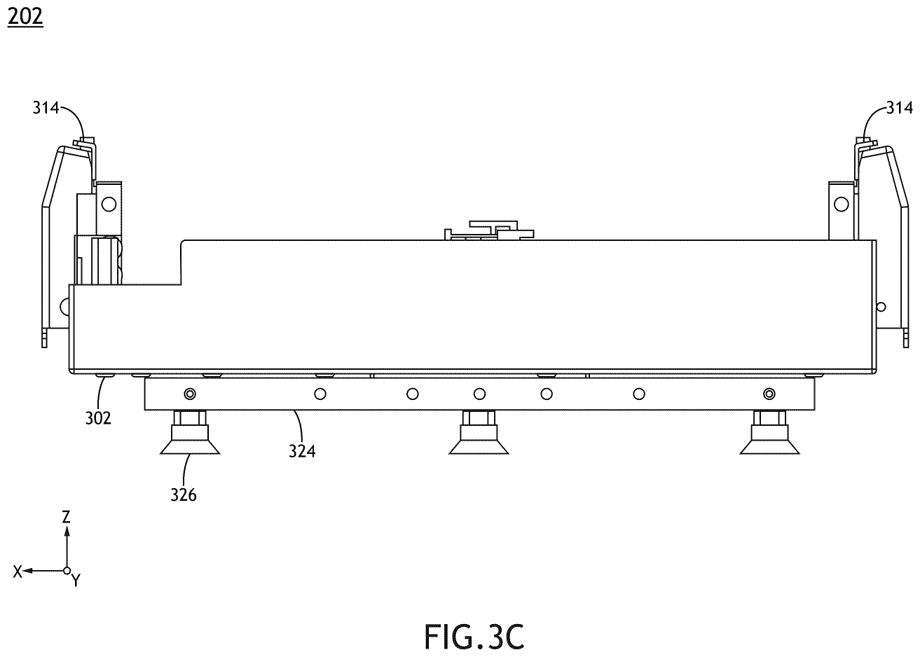

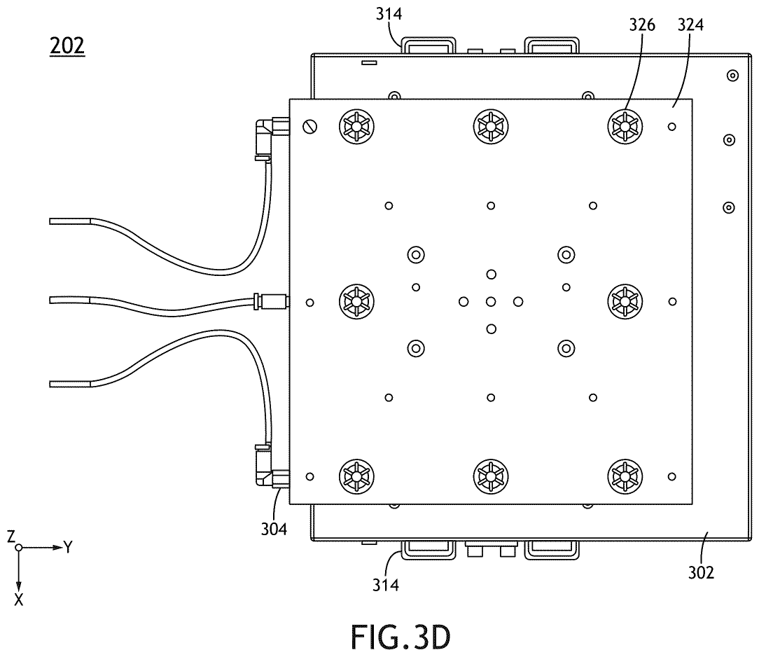

FIGS. 3A-3D depict the mechatronic-indexing system 202, in accordance with one or more embodiments of the present disclosure. The mechatronic-indexing system 202 may include one or more components, such as, but not limited to, an indexing frame 302, vacuum interfaces 304, a linear actuator 306, a carriage 308, linear rails 310, shafts 312, fasteners 314, bearings 316, a home position sensor 318, end position sensors 320, end stops 322, a pick-up gear 324, nozzles 326, and the like.

The indexing frame 302 may house one or more components of the mechatronic-indexing system 202. The indexing frame 302 may be a rigid body upon which one or more components of the mechatronic-indexing system 202 may be affixed. For example, the linear rails 310, the shafts 312, the fasteners 314, the home position sensor 318, the end position sensors 320, and/or the end stops 322 may be affixed to the indexing frame 302. The indexing frame 302 may define the outer boundary and thus the motion stroke of the carriage 308.

The carriage 308 may be a carrier. The carriage 308 may be configured to translate relative to the indexing frame 302 along the linear rails 310 and/or the shafts 312.

The bearings 316 may be coupled to the carriage 308. For example, the bearings 316 may be coupled to an underside of the carriage 308. The bearings 316 may allow for smooth movement of the carriage 308 along the linear rails 310. The linear rails 310 may be linear guide rails. For example, the linear rails 310 may be horizontal-mount linear rails. The bearings 316 and the linear rails 310 may form a prismatic joint between the carriage 308 and the indexing frame 302. The prismatic joint may also be referred to as a linear motion guide, a slider, a sliding joint, or the like. The prismatic joint may constrain the carriage 308 to one degree-of-freedom relative to the indexing frame 302. For example, the prismatic joint may cause the carriage 308 to translate horizontally relative to the indexing frame 302 along the X-axis. The carriage 308 is thus prevented from translating along the Y-axis or the Z-axis and/or rotating about any of the axes relative to the indexing frame 302. Thus, the bearings 316 and the linear rails 310 may ensures the linear motion of the carriage 308 along the X-axis is perpendicular to the Y-axis motion of the pick-and-place head 102 along the rail 104.

The linear rails 310 and the shafts 312 may be aligned in parallel. For example, the linear rails 310 and the shafts 312 may be aligned in parallel along the X-axis. The linear rails 310 and the shafts 312 may be perpendicular to the horizontal translation along the rail 104.

The linear actuator 306 may be coupled to the carriage 308. The linear actuator 306 may be configured to translate the carriage 308 relative to the indexing frame 302 along the shafts 312. The linear actuator 306 may cause the carriage 308 to horizontally translate relative to the indexing frame 302 along the X-axis.

The linear actuator 306 may include any suitable type of linear actuator, such as, but not limited to, a linear servo motor 306a, a pneumatic cylinder 306b, or the like. The linear servo motor 306a may provide some advantages over the pneumatic cylinder 306b, such as an increase in speed and/or accuracy in positioning the carriage 308 relative to the indexing frame 302. The mechatronic-indexing system 202 may index the sample 101, the carriage 308, and/or the pick-up gear 324 between one or more positions. For example, the linear servo motor 306a may cause the mechatronic-indexing system 202 to index the sample 101, the carriage 308, and/or the pick-up gear 324 between at a pair of end positions, at a home position between the pair of end positions, and/or at any number of positions therebetween. By way of another example, the pneumatic cylinder 306b may cause the mechatronic-indexing system 202 to index the sample 101, the carriage 308, and/or the pick-up gear 324 at the pair of end positions and at the home position. In this regard, the linear servo motor 306a may provide additional indices than the pneumatic cylinder 306b (e.g., to allow the controller 110 to stitch together more of the images 105 when the sample 101 is much larger or the field-of-view 103 is much smaller).

The vacuum interfaces 304 may be a vacuum interface and/or air interface by which the mechatronic-indexing system 202 is configured to receive vacuum and/or air from the base 204. For example, the vacuum interfaces 304 may be configured to receive vacuum from one or more of the pickers 208. In embodiments, the vacuum interfaces 304 may be receive the vacuum and/or air from a dedicated supply of the base 204. The vacuum interfaces 304 may be coupled to one of the carriage 308 or the pick-up gear 324. As depicted, the vacuum interfaces 304 is coupled to a vertical side of the pick-up gear 324, where a top side of the pick-up gear 324 is coupled to the carriage 308 and a bottom side of the pick-up gear 324 includes the nozzles 326, although this is not intended to be limiting.

The pick-up gear 324 may be coupled to the carriage 308. The translation of the carriage 308 relative to the indexing frame 302 may cause the pick-up gear 324 to translate relative to the indexing frame 302. The indexing frame 302 may be disposed between the carriage 308 and the pick-up gear 324. For example, the carriage 308 may be disposed on a top side of the indexing frame 302 and the pick-up gear 324 may be disposed on a bottom side of the indexing frame 302. The pick-up gear 324 may be coupled to the carriage 308 with the indexing frame 302 between the carriage 308 and the pick-up gear 324 via a coupling interface between the pick-up gear 324 and the carriage 308 disposed in one or more slots in the indexing frame 302.

The pick-up gear 324 may include nozzles 326. The nozzles 326 may receive the vacuum and/or air from the vacuum interfaces 304. In this regard, the nozzles 326 may refer to a vacuum or suction device. The pick-up gear 324 may pick up the samples 101 by the nozzles 326. The nozzles 326 may pick up the samples 101 by action of a vacuum. The pick-up gear 324 may be configured to pick up the samples 101 via suction using the nozzles 326. The nozzles 326 may include separate vacuum supplies or a shared vacuum supply. The nozzles 326 may be arranged in a select arrangement on the pick-up gear 324. The nozzles 326 may be arranged in rows and/or columns. In the example depicted, the nozzles 326 are arranged in three rows and three columns, although this is not intended to be limiting. The nozzles 326 may be adjustable in number and/or pitch. The pitch may include an X-pitch and/or a Y-pitch.

The design of the mechatronic-indexing system 202 may be scaled according to the size of the samples 101. For example, the size of the pick-up gear 324 may be matched to the size of the samples 101. The mechatronic-indexing system 202 may be designed to pick-and-place any size of the samples 101, such as, but not limited to, 80 mm, 130 mm, 150 mm, 160 mm, 200 mm, a value therebetween, or more. In this regard, the pick-and-place head 102 may be configured to support any current size of the sample 101 by adjusting the size of the pick-up gear 324, adjusting the number and/or pitch of the nozzles 326, and/or a length of travel between the end positions of the carriage 308. The mechatronic-indexing system 202 may be field upgradable by making such changes.

The home position sensor 318 and the end position sensors 320 may detect the position of the carriage 308 in real time to ensure a software flow sequences and safety functions of the mechatronic-indexing system 202. For example, the positions from the home position sensor 318 and the end position sensors 320 may be provided to the controller 110 as feedback for controlling the position of the carriage 308 relative to the indexing frame 302 via the linear actuator 306. The end position sensors 320 may detect the carriage 308 is at the end position. The home position sensor 318 may detect the carriage 308 is at a home position. The home position of the carriage 308 may be midway between the end positions. The mechatronic-indexing system 202 may include a pair of the end position sensors 320, one for each of the opposing end positions of the carriage 308. The home position sensor 318 and the end position sensors 320 may include any suitable type of sensor, such as, but not limited to, a proximity sensor, a magnetic sensor, a contact switch sensor, a capacitive sensor, or the like. In embodiments, the home position sensor 318 and the end position sensors 320 may be replaced by or supplemented with a linear encoder. The linear encoder may be added to improve accuracy and/or repeatability when positioning the carriage 308 relative to the indexing frame 302.

The end stops 322 may be disposed at opposing ends of the linear rails 310 and/or the shafts 312. The end stops 322 may define the end positions for the carriage 308. For example, the carriage 308 may be disposed at the end position when abutting the end stops 322. The end stops 322 may be adjustable to ensure accurate positioning at the end positions. A maximum stitching stroke may be defined as a length between the end stops 322. The maximum stitching stroke may be extended by modifying the end stops 322.

The fasteners 314 may be configured to attach and detach the mechatronic-indexing system 202 to and from the base 204. For example, the fasteners 314 may be configured to attach and detach the indexing frame 302 of the mechatronic-indexing system 202 to and from the base frame 206 of the base 204. The fasteners 314 may include any suitable type of fastener, such as, but not limited to, a cuff latch fastener. The fasteners 314 may provide a quick detach and attachment. In embodiments, the fasteners 314 are disposed at opposing ends of the shafts 312 and/or the linear rails 310.

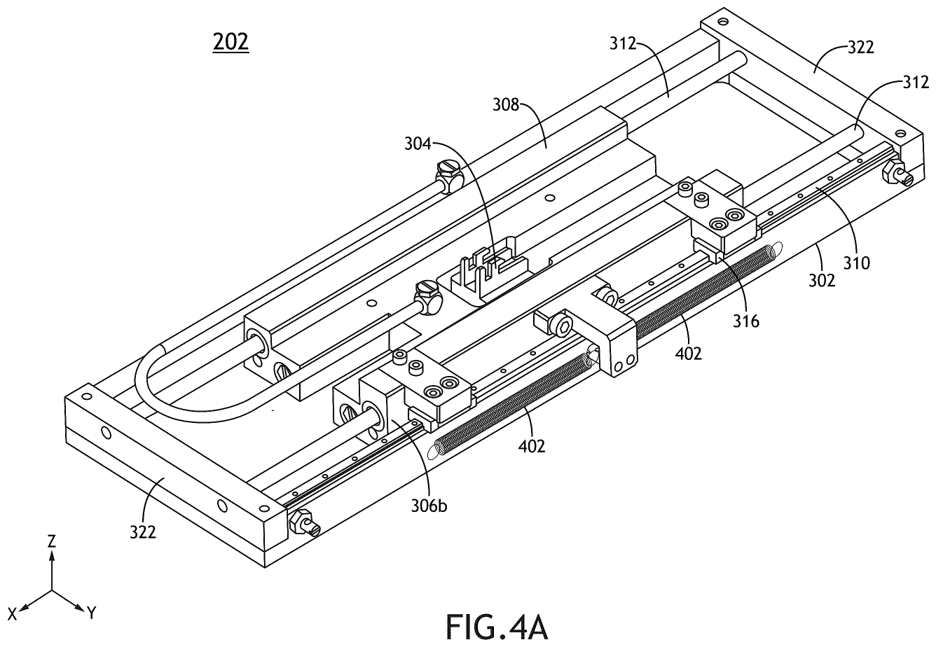

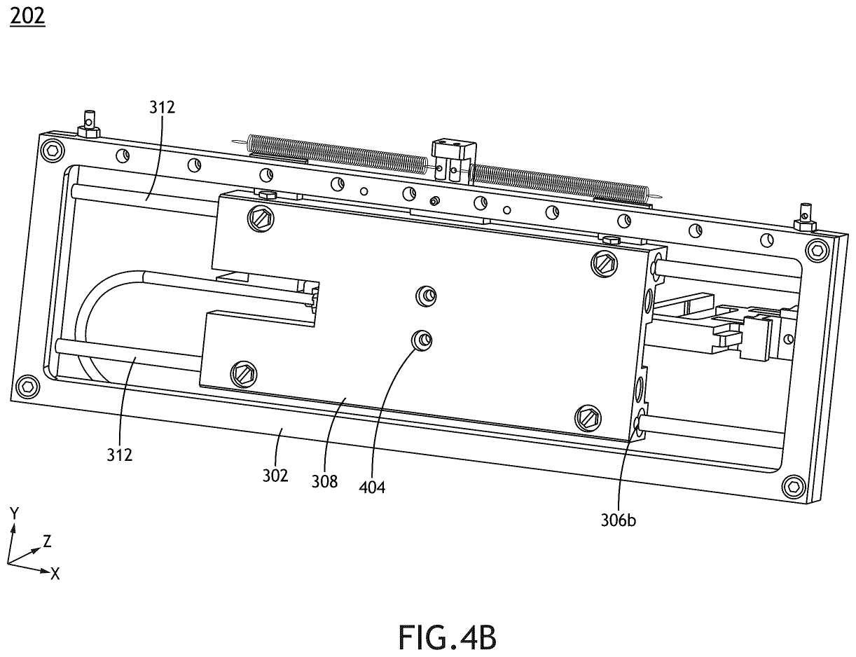

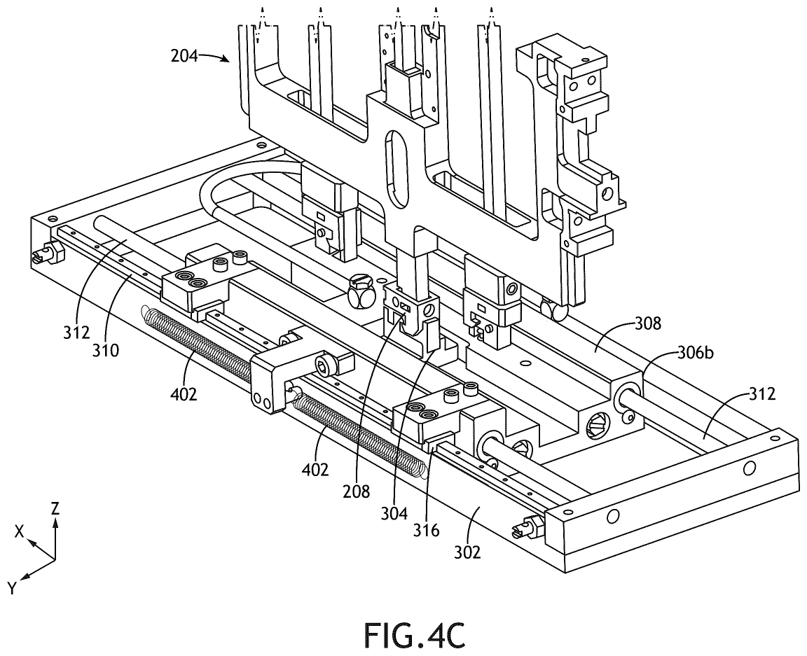

FIGS. 4A-4C depict a portion of the mechatronic-indexing system 202, in accordance with one or more embodiments of the present disclosure. In embodiments, the mechatronic-indexing system 202 may include the pneumatic cylinder 306b. The pneumatic cylinder 306b may include, but is not limited to, a double-acting pneumatic cylinder. The double-acting pneumatic cylinder may be configured to translate the carriage 308 between both end positions. The mechatronic-indexing system 202 may also include a pair of centering springs 402. The pair of centering springs 402 may be homing and/or return springs. The pair of centering springs 402 may be coupled between the indexing frame 302 and the carriage 308. The pair of centering springs 402 may provide a means for returning controlling members to the home position. The pair of centering springs 402 may center the carriage 308 on the home position when the pneumatic cylinder 306b is not engaged.

In embodiments, the vacuum interfaces 304 may be coupled to the carriage 308. For example, the vacuum interfaces 304 may be coupled to a top side of the carriage 308, and where the pick-up gear 324 is coupled to a bottom side of the carriage 308. The vacuum interfaces 304 may be configured to couple with the pickers 208 of the base 204 by which the vacuum interfaces 304 may receive the vacuum and/or air. The vacuum interfaces 304 may have an internal air channel and rubber seals to ensure vacuum & compressed air flow between the carriage 308 and the pickers 208. The mechatronic-indexing system 202 may include one or more of the vacuum interfaces 304 for coupling with a respective number of the pickers 208. In the example depicted, the mechatronic-indexing system 202 includes one or more of the vacuum interfaces 304 which couples to a middle row of the pickers 208, although this is not intended as a limitation of the present disclosure. The pickers 208 which do not couple with the vacuum interfaces 304 may be moved upwards to provide clearance with the carriage 308.

The carriage 308 may distribute the vacuum and/or air to the pick-up gear 324 via a distribution channel 404. The distribution channel 404 may be disposed on a bottom side of the carriage 308. The distribution channel 404 may include a screw-thread connection between the carriage 308 and the pick-up gear 324. The distribution channel 404 may include an internal air channel and rubber seals to ensure vacuum and air may flow between the carriage 308 and the pick-up gear 324.

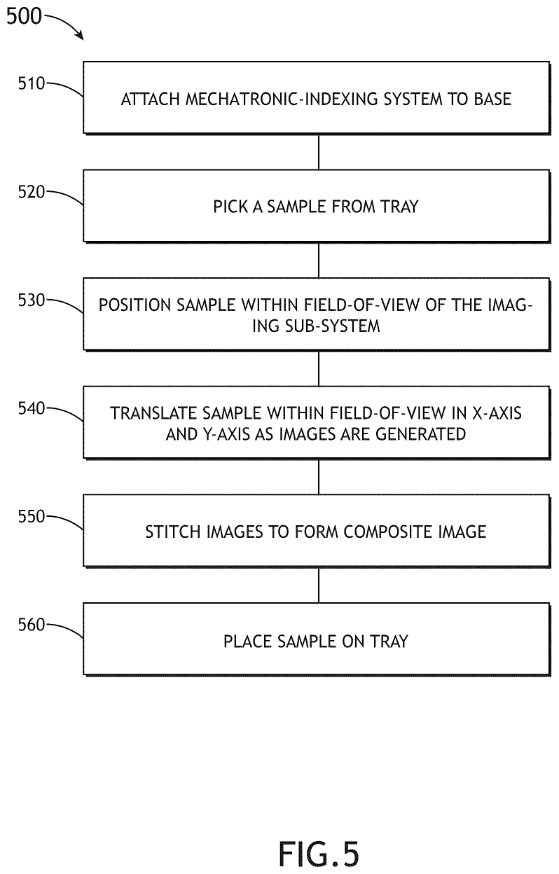

FIG. 5 depicts a flow diagram of a method 500, in accordance with one or more embodiments of the present disclosure. The method 500 provides a means for generating composite images of the samples 101 which are larger than the field-of-view of the imaging sub-system 106 using the mechatronic-indexing system 202. The method 500 may be performed without adjusting a pitch of the pickers 208 and without translating the imaging sub-system 106. The embodiments and the enabling technologies described previously herein in the context of the optical system 100 should be interpreted to extend to the method. It is further noted, however, that the method 500 is not limited to the architecture of the optical system 100.

In a step 510, a mechatronic-indexing system may be attached to a base of a pick-and-place head. For example, the mechatronic-indexing system 202 may be attached to the base 204 of the pick-and-place head 102. The indexing frame 302 of the mechatronic-indexing system 202 may be attached to the base frame 206 of the base 204 of the pick-and-place head 102. For instance, the indexing frame 302 of the mechatronic-indexing system 202 may be attached to the base frame 206 by the fasteners 314. The vacuum interfaces 304 may also be attached to a vacuum source and/or an air source of the base 204.

In a step 520, the mechatronic-indexing system may pick a sample from a tray. For example, the mechatronic-indexing system 202 may pick the sample 101 from the tray 108. The mechatronic-indexing system 202 may pick the sample 101 from the tray 108 by translating the pick-and-place head 102 along the Z-axis up to the sample 101 and suctioning the sample 101 via the nozzles 326.

In a step 530, the pick-and-place head may position the sample within a field-of-view of an imaging sub-system. For example, the pick-and-place head 102 may position the sample 101 within the field-of-view 103 of the imaging sub-system 106. The pick-and-place head 102 may position the sample 101 within the field-of-view 103 of the imaging sub-system 106 by translating along the rail 104 on the Y-axis. The sample 101 may be larger than the field-of-view 103.

In a step 540, the pick-and-place head may translate the sample within the field-of-view in both the X-axis and the Y-axis as the imaging sub-system generates images of the sample. For example, the pick-and-place head 102 may translate the sample 101 within the field-of-view in both the X-axis and the Y-axis as the imaging sub-system 106 generates the images 105 of the sample 101. The pick-and-place head 102 may translate the sample 101 in the Y-axis by translating along the rail 104. The mechatronic-indexing system 202 of the pick-and-place head 102 may translate the sample 101 in the X-axis by causing the carriage 308 and pick-up gear 324 to translate relative to the indexing frame 302. The linear actuator 306 may translate the carriage 308 and the pick-up gear 324 between the home position and each of the end positions. The images 105 may be generated at each of the home position and the end positions. The images 105 may be tiled in a grid. In this example, nine of the images 105 may be generated (e.g., three images at each of the home position, first end position, and second end position). The images 105 may also be generated at positions between the home position and the end positions where the linear actuator 306 is the linear servo motor 306a to further support larger of the samples 101 and/or smaller of the field-of-view 103.

The motion along the X-axis and the Y-axis may include a motion period and/or a rest period. The motion period may be the period in which the sample 101 is moved. The rest period may be a period in which the sample 101 is not moved as the images 105 are generated. A combined length of the motion period and the dwell period may be on the order of hundreds of milliseconds (e.g., 200 milliseconds). Thus, the linear actuator 306 may enable rapid translation along the X-axis before coming to rest.

In a step 550, a controller may receive the images and stitch the images together to form a composite image including the entire portion of the sample. For example, the controller 110 may receive the images 105 and stitch the images 105 together to form a composite image including the entire portion of the sample 101. The images 105 may include an overlap for registration when stitching. The composite image may include each of the images 105 generated at the home position, the end positions, and/or the positions therebetween. The controller 110 may include dedicated software algorithms to combine these images 105 using overlapping zones within the images 105.

In a step 560, the mechatronic-indexing system may place the sample on the tray. For example, the mechatronic-indexing system 202 may place the sample 101 on the tray 108. The mechatronic-indexing system 202 may place the sample 101 on the tray 108 by translating over the tray 108 and forcing the air through the nozzles 326. Thus, the optical system 100 may generate composite images of the bottom of the sample 101 for defect inspection and/or metrology purposes.

Referring generally again to the figures. The mechatronic-indexing system 202 may advantageously provide stitching capability without motorizing the pickers 208 and/or the imaging sub-system 106. Motorizing the pickers 208 and/or the imaging sub-system 106 may require fine tuning the hardware position, dedicated alignment & calibration, which the mechatronic-indexing system 202 may alleviate. The mechatronic-indexing system 202 may be an add-on function to the base 204. The mechatronic-indexing system 202 may provide the stitching functionality without changing the base 204 and/or the imaging sub-system 106. The mechatronic-indexing system 202 may be used on any of a variety of the pick-and-place heads 102.

The term “sample” may include to a substrate formed of a semiconductor or non-semiconductor material (e.g., thin filmed glass, or the like). For example, a semiconductor or non-semiconductor material may include, but is not limited to, monocrystalline silicon, gallium arsenide, indium phosphide, or a glass material. A substrate may include one or more layers. For example, such layers may include, but are not limited to, a resist (including a photoresist), a dielectric material, a conductive material, and a semiconductive material. Many different types of such layers are known in the art, and the term sample as used herein is intended to encompass a substrate on which all types of such layers may be formed. One or more layers formed on a substrate may be patterned or un-patterned. For example, a substrate may include a plurality of dies, each having repeatable patterned features. Formation and processing of such layers of material may ultimately result in completed devices. Many different types of devices may be formed on a substrate, and the term substrate as used herein is intended to encompass a substrate on which any type of device known in the art is being fabricated. Further, for the purposes of the present disclosure, the term substrate and wafer should be interpreted as interchangeable. In addition, for the purposes of the present disclosure, the terms patterning device, mask and reticle should be interpreted as interchangeable. The sample may also include any component during a semiconductor front end of line process, back end of line process, or another semiconductor process. For example, the sample may include a semiconductor package. The inspection or metrology of the package may be performed at any point during the semiconductor process including where the sample is an intermediate assembly and/or a finished package. The package may include dies, interposers, substrates, and the like. For example, the package may be a die-to-die stack, die-to-wafer stack, wafer-to-wafer stack, die-to-interposer stack, a ball-grid array package, a landing-grid array package, a 2.5D integration, a 3D integration, a chip-scale package, a system-in-package, a system on integrated chip, a multi-chip module, a chip-on-wafer package, a wafer-on-substrate, a chip-on-wafer-on-substrate, a fan out package, a package-on-package, or the like. The package may include various connections, such as interconnections, hybrid bonds, bumps, pads, balls, through-silicon vias, or the like. The package may also include stiffeners, lids, molding, or the like. Any of the various samples, substrates, and/or packages may include a form factor for which the stitching functionally may be beneficial.

A controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

The controller may include one or more processors configured to execute program instructions maintained on a memory medium, causing the controller to perform any of the various methods.

The one or more processors may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the systems, as described throughout the present disclosure.

The memory medium may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet and the like).

It is further contemplated that each of the embodiments of the methods described above may include any other step(s) of any other method(s) described herein. In addition, each of the embodiments of the method described above may be performed by any of the systems described herein.

In the case of a control algorithm, one or more program instructions or methods may be configured to operate via proportional control, feedback control, feedforward control, integral control, proportional-derivative (PD) control, proportional-integral (PI) control, proportional-integral-derivative (PID) control, or the like.

It is noted herein that the one or more components of the system may be communicatively coupled to the various other components of system in any manner known in the art. For example, the one or more processors may be communicatively coupled to each other and other components via a wireline (e.g., copper wire, fiber optic cable, and the like) or wireless connection (e.g., RF coupling, IR coupling, WiMax, Bluetooth, 3G, 4G, 4G LTE, 5G, and the like). By way of another example, the controller may be communicatively coupled to one or more components of the system via any wireline or wireless connection known in the art.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A mechatronic-indexing system comprising:
an indexing frame,
a carriage;
a shaft, wherein the shaft is affixed to the indexing frame;
a linear actuator, wherein the linear actuator is coupled to the carriage, wherein the linear actuator is configured to translate the carriage relative to the indexing frame along the shaft;
a pick-up gear, wherein the pick-up gear is coupled to the carriage, wherein the indexing frame is disposed between the pick-up gear and the carriage, wherein the pick-up gear comprises a plurality of nozzles; and
a vacuum interface, wherein the vacuum interface is coupled to one of the carriage or the pick-up gear, wherein the plurality of nozzles are configured to receive vacuum from the vacuum interface.

2. The mechatronic-indexing system of claim 1, comprising:
a linear rail, wherein the linear rail is affixed to the indexing frame, wherein the linear rail and the shaft are aligned in parallel; and
a bearing, wherein the bearing is coupled to the carriage, wherein the bearing and the linear rail form a prismatic joint between the carriage and the indexing frame.

3. The mechatronic-indexing system of claim 1, wherein the linear actuator comprises a linear servo motor.

4. The mechatronic-indexing system of claim 1, wherein the linear actuator comprises a pneumatic cylinder, wherein the mechatronic-indexing system comprises a pair of centering springs, wherein the pair of centering spring are coupled between the indexing frame and the carriage.

5. The mechatronic-indexing system of claim 1, wherein the vacuum interface is coupled to the pick-up gear.

6. The mechatronic-indexing system of claim 5, wherein the vacuum interface is coupled to a vertical side of the pick-up gear, wherein a top side of the pick-up gear is coupled to the carriage and a bottom side of the pick-up gear includes the plurality of nozzles.

7. The mechatronic-indexing system of claim 1, wherein the vacuum interface is coupled to the carriage.

8. The mechatronic-indexing system of claim 7, wherein the vacuum interface is coupled to a top side of the carriage, wherein the pick-up gear is coupled to a bottom side of the carriage, wherein the carriage distributes the vacuum to the pick-up gear via a distribution channel.

9. The mechatronic-indexing system of claim 1, comprising one or more position sensors, wherein the one or more position sensors are affixed to the indexing frame, wherein the one or more position sensors are configured to detect a position of the carriage.

10. The mechatronic-indexing system of claim 9, wherein the one or more position sensors comprise a home position sensor and end position sensors, wherein the home position sensor is configured to detect the carriage is at a home position, wherein the end position sensors are configured to detect the carriage is at end positions, wherein the home position is midway between the end positions.

11. The mechatronic-indexing system of claim 1, comprising end stops, wherein the end stops are affixed to the indexing frame, wherein the end stops are disposed at opposing ends of the shaft.

12. The mechatronic-indexing system of claim 1, comprising a fastener, wherein the fastener is affixed to the indexing frame, wherein the fastener is configured to attach and detach the mechatronic-indexing system to and from a base of a pick-and-place head.

13. The mechatronic-indexing system of claim 1, wherein the pick-up gear is configured to pick up and place a sample to and from a tray.

14. A pick-and-place head comprising:
a mechatronic-indexing system comprising:
an indexing frame,
a carriage;
a shaft, wherein the shaft is affixed to the indexing frame;
a linear actuator, wherein the linear actuator is coupled to the carriage, wherein the linear actuator is configured to translate the carriage relative to the indexing frame along the shaft;
a pick-up gear, wherein the pick-up gear is coupled to the carriage, wherein the indexing frame is disposed between the pick-up gear and the carriage, wherein the pick-up gear comprises a plurality of nozzles; and
a vacuum interface, wherein the vacuum interface is coupled to one of the carriage or the pick-up gear, wherein the plurality of nozzles are configured to receive vacuum from the vacuum interface; and
a base, wherein the mechatronic-indexing system is configured to attach to and detach from the base.

15. The pick-and-place head of claim 14, wherein the pick-and-place head is configured to translate horizontally along a Y-axis, wherein the linear actuator is configured to cause the carriage to translate horizontally relative to the indexing frame along an X-axis.

16. The pick-and-place head of claim 14, wherein the base comprises a base frame and a plurality of pickers, wherein the indexing frame is configured to attach to and detach from the base frame.

17. The pick-and-place head of claim 16, wherein the vacuum interface is configured to receive the vacuum from one or more of the plurality of pickers.

18. An optical system comprising:
a pick-and-place head comprising:
a mechatronic-indexing system comprising:
an indexing frame,
a carriage;
a shaft, wherein the shaft is affixed to the indexing frame;
a linear actuator, wherein the linear actuator is coupled to the carriage, wherein the linear actuator is configured to translate the carriage relative to the indexing frame along the shaft;
a pick-up gear, wherein the pick-up gear is coupled to the carriage, wherein the indexing frame is disposed between the pick-up gear and the carriage, wherein the pick-up gear comprises a plurality of nozzles; and
a vacuum interface, wherein the vacuum interface is coupled to one of the carriage or the pick-up gear, wherein the plurality of nozzles are configured to receive vacuum from the vacuum interface; and
a base, wherein the mechatronic-indexing system is configured to attach to and detach from the base;
a rail, wherein the pick-and-place head is coupled to the rail, wherein the pick-and-place head is configured to translate horizontally along the rail along a Y-axis, wherein the linear actuator is configured to cause the carriage to translate horizontally relative to the indexing frame along an X-axis;
a tray, wherein the pick-up gear is configured to pick up and place a sample to and from a tray; and
an imaging sub-system, wherein the pick-and-place head is configured to horizontally translate along the rail to place the sample within a field-of-view of the imaging sub-system, wherein the sample is larger than the field-of-view, wherein the imaging sub-system is configured to generate a plurality of images of the sample while the pick-and-place head translates the sample within the field-of-view in both the X-axis and the Y-axis.

19. The optical system of claim 18, comprising a controller, wherein the controller is configured to receive the plurality of images and stitch the plurality of images together to form a composite image of the sample.

20. A method comprising:
attaching a mechatronic-indexing system to a base of a pick-and-place head, wherein the mechatronic-indexing system comprises:
an indexing frame,
a carriage;
a shaft, wherein the shaft is affixed to the indexing frame;
a linear actuator, wherein the linear actuator is coupled to the carriage, wherein the linear actuator is configured to translate the carriage relative to the indexing frame along the shaft;
a pick-up gear, wherein the pick-up gear is coupled to the carriage, wherein the indexing frame is disposed between the pick-up gear and the carriage, wherein the pick-up gear comprises a plurality of nozzles; and
a vacuum interface, wherein the vacuum interface is coupled to one of the carriage or the pick-up gear, wherein the plurality of nozzles are configured to receive vacuum from the vacuum interface;
picking a sample from a tray using the pick-up gear of the mechatronic-indexing system;
positioning the sample within a field-of-view of an imaging sub-system, wherein the sample is larger than the field-of-view;
translating the sample within the field-of-view in both an X-axis and a Y-axis using the pick-and-place head as the imaging sub-system generates a plurality of images of the sample;
stitching the plurality of images together to form a composite image of the sample; and
placing the sample on the tray.
